(19) United States
(12) Patent Application Publication
(10) Pub. No.: US 2022/0180666 A1
(43) Pub. Date: Jun. 9, 2022

(54) Method to Provide a Speech Dialog in Sign Language in a Speech Dialog System for a Vehicle

(71) Applicant: Volkswagen Aktiengesellschaft, Wolfsburg (DE)

(72) Inventor: Jewgeni Rose, Braunschweig (DE)

(73) Assignee: Volkswagen Aktiengesellschaft, Wolfsburg (DE)

(21) Appl. No.: 17/441,341

(22) PCT Filed: Mar. 11, 2020
(86) PCT No.: PCT/EP2020/056407

§ 371 Date: Sep. 21, 2021

(30) Foreign Application Priority Data
Mar. 25, 2019 (DE) 10 2019 204 054.3

(51) Int. Cl. G06V 40/20; G06V 20/59; B60W 40/08

(52) U.S. Cl. CPC G06V 40/28; G06V 20/59; B60W 2554/4049; B60W 2555/20; B60W 40/08

(57) ABSTRACT

A method to provide a speech dialog in sign language in a speech dialog system for a vehicle is disclosed. In the method, the following steps are carried out: performing an optical detection of input information from a vehicle occupant; performing an evaluation of the detected input information; and providing a visual output in sign language depending on the evaluation.

### CROSS-REFERENCE TO RELATED APPLICATIONS

This application claims priority to German Patent Application No. DE 10 2019 204 054.3, filed on Mar. 25, 2019 with the German Patent and Trademark Office. The contents of the aforesaid patent application are incorporated herein for all purposes.

### TECHNICAL FIELD

The present invention relates to a method to provide a speech dialog in sign language in a speech dialog system for a vehicle.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

Speech dialog systems in a vehicle enable operation of the vehicle as well as an exchange of information with the vehicle through verbal communication. In times of the automation of driving functions, an additional driving experience may thereby be created that consists in being able to communicate with the vehicle to exchange information and/or for entertainment. Gesture control of instruments in the vehicles is also known. However, carrying out dialogs with the vehicle is still problematic for people with difficulties with the spoken language, or respectively deaf and hard-of-hearing people.

### SUMMARY

A need exists to overcome the above-described disadvantages at least in part and to provide a solution for a nonacoustic speech dialog system.

The need is addressed by a method, by a system, and by a vehicle according to the independent claims.

Embodiments of the invention are described in the dependent claims, the following description, and the drawings.

### BRIEF DESCRIPTION OF THE DRAWINGS

FIG. 1 shows a schematic depiction of parts of an embodiment of a system from the perspective of an interior of the vehicle; and

FIG. 2 shows a schematic flow chart of an embodiment of a method.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

Herein, features and details that are described in connection with the discussed method also apply to the discussed system as well as to the discussed vehicle, and in each case vice versa, and therefore reference is or may be made interchangeably in the disclosure thereof.

In a first exemplary aspect of the teachings herein, a method for providing a speech dialog in sign language in a speech dialog system is discussed, for example a nonacoustic speech dialog system, for a vehicle. In doing so, it is for example provided that the following is performed, e.g., sequentially in the indicated or any desired sequence, wherein individual steps may if applicable also be repeated:
perform an optical detection of input information from a vehicle occupant, for example by an imaging assembly,
perform an evaluation of the detected input information, for example by a processing assembly,
provide visual output in sign language depending on the evaluation, for example by an output assembly.

In this way, a nonacoustic execution of a speech dialog using the speech dialog system may be provided in order to carry out natural language dialogs with the vehicle. The natural language dialog is for example formed by the input information (for example in the form of a “speech”, or question, or answer, or instruction), and the output relating thereto (for example in the form of a “response” or answer to the question, or question, or reply to the instruction). A particular benefit in this case is that the output is provided in sign language to also enable dialog for people for whom the use of a spoken language for dialog is associated with difficulties. It may therefore be possible for the dialog to be completely without spoken language.

It may furthermore be possible for the input information to have information on a sign language of the vehicle occupant. This allows the dialog provided by the speech dialog system to be entirely provided in sign language. In this regard, the input information comprises for example information on a gesture, and/or facial expression, and/or silently spoken words, and/or body posture of the vehicle occupant that may be analyzed through the evaluation by a processing assembly. In order to detect input information with this information, a recorded image of the vehicle occupant may for example be made by an imaging assembly. The evaluation may furthermore comprise an image analysis and/or methods of machine learning in order for example to perform a classification of the input information with respect to predefined gestures and/or signs. The situation in the vehicle's interior may be analyzed in this way by the speech dialog system and utilized in the dialog.

It is furthermore optionally provided (in some embodiments) that the performance of the evaluation comprises the following steps:
carry out a detection of an interaction of the vehicle occupant with the speech dialog system in the sign language by using the input information, wherein for example the input information is configured as a recorded image of the vehicle occupant in order to detect the interaction at least as a gesture by the vehicle occupant by using the recorded image,
perform an analysis, for example image analysis, of the input information to translate the sign language into contentual translation information that may be evaluated for the speech dialog system, for example text information, for example only when the interaction has been successfully detected,
optional: perform a detection of another gesture of the vehicle occupant using the input information that is specific to additional information,
generate an answer by using the translation information, and for example by using the additional information, to output the answer in the sign language by the visual output.

This enables a reliable evaluation of the input information to provide the dialog. The generation of the answer may furthermore for example comprise a contentual analysis of the translation information in order for example to determine contentual information as the answer whose content relates to the input information (for example as a question). The output may be in the form of the output of a graphic avatar, and/or an abstract form, and/or by signs (i.e., sign-based), and if applicable also as audio output.

It may be possible for at least one gesture by the vehicle occupant to be detectable in the evaluation of the input information. This gesture by the vehicle occupant may be detected as a gesture in the context of the sign language and correspondingly serve to translate the sign language into the translation information. Furthermore, the gesture may also be detected as an additional gesture that is specific to additional information. An additional gesture for example consists in pointing to an object that correspondingly provides the selected object as the additional information. By using the detected additional gesture, the additional information, in addition to the translation, may be used in the evaluation to generate the answer. For example, the translation information indicates a certain question relating to the object. In other words, the translation information may indicate the function, and the additional information may indicate a parameter for this function. The answer may then be generated as an output of the function.

The additional gesture and the additional information are for example determined in that the imaging assembly, for example a first imaging unit such as a camera, detects the input information from which the additional gesture may be derived (such as pointing to the object). The additional information (i.e., the specific object) may for example be determined by the querying (additional detection) of at least one additional imaging assembly, and/or at least one additional imaging unit of the vehicle by which the environment of the vehicle and therefore the object is detected. To accomplish this, for example directional information is derived using the additional gesture (what is the pointing direction?) and compared with the additional detection of the object. It is also conceivable for the object to be identified by using the directional information in that location information on a current location of the vehicle is evaluated, and for example compared with environment information and the direction information.

According to some embodiments, it may be provided that the answer comprises at least one of the following pieces of information (with the following content):
object information on an object in an environment of the vehicle, wherein for example in this regard the additional information provides a selection of the object, for example as an indicated direction toward the object,
weather information, for example on weather at the location of the vehicle,
environmental information, for example information on a current location of the vehicle,
message information, for example on local messages at the location of the vehicle,
media information such as for example videos or literature, etc.,
   wherein for example the information is filtered with respect to an availability of an output of the information in the sign language to generate the answer. This makes it possible to provide a broad informational spectrum for the speech dialog. The further gesture according to the additional information is configured to select the object, for example as a finger gesture, etc., which may gesture toward the object. According to the filter, for example only such content may be considered that is suitable to be output in sign language. It may also be possible for this purpose to translate information in text form into sign language by a method and/or system according to the present teachings, for example by means of the processing assembly. For this purpose, the processing assembly may if applicable also communicate with an external data processing system in order for example to perform this translation via an external server, or respectively via cloud computing.

A system for a vehicle to provide a speech dialog in sign language is the subject of a second exemplary aspect of the teachings herein. The system may for example be designed as a vehicle electronic system and may therefore be suitable to be permanently integrated in the vehicle. In this regard, it is provided that the system has at least one of the following components:
an imaging assembly, for example a camera system, for detecting input information from a vehicle occupant, wherein the input information is for example configured as image information, for example a recorded image,
a(n) (for example electronic) processing assembly for evaluating the detected input information, wherein the processing assembly is for example configured as a control unit, and/or an electronic system, and/or a microcontroller, and/or the like,
an output assembly for visual output in sign language depending on the evaluation.

Therefore, the system yields the same benefits as those described in detail with reference to aforementioned method according to the first aspect. In addition, the system may be suitable for performing the method according to the first aspect. It is furthermore conceivable that the system is designed as a speech dialog system of a method according to the first aspect in order to perform the steps of the method.

The system may for example be designed as a technical component in a vehicle that monitors the interior of the vehicle with the assistance of the imaging assembly, for example in the form of a camera system, and is capable of recognizing when a vehicle occupant (passenger) is interacting with the system, for example the speech dialog system (speech assistant) and translates the sign language into text. This allows the speech assistant to behave just as if the user were to speak using speech with the speech assistant. The imaging assembly is for example installed in the front in the instrument panel or in the rearview mirror and therefore offers precise user monitoring.

Some embodiments provide that the imaging assembly is designed as an infrared camera in order to optically detect at least one gesture of the vehicle occupant. The camera may for example be designed for detection in the near and/or far infrared range to detect the input information very reliably and with little interference.

Optionally, it may be provided that the output assembly comprises at least one display, for example an LED display, for the vehicle interior in order to output the visual output as a visualization of an answer to the input information in the sign language, wherein the output assembly is for example designed as an instrument cluster for the vehicle. This enables convenient recognition of the output in the sign language.

A vehicle with a system according to the present aspect is also a subject of the teachings herein. It may be beneficial for the vehicle to be designed as an autonomous vehicle, i.e., for example as a self-driving motor vehicle. Such a vehicle may be driven, controlled and parked without the influence of a human driver. In this case, the use of the speech dialog system is particularly recommendable since none of the vehicle occupants is occupied with controlling the vehicle.

It is also beneficial if the vehicle is designed as a motor vehicle, for example a trackless land motor vehicle, for example a hybrid vehicle that comprises an internal combustion engine and an electric machine for the traction, or as an electric vehicle, for example having a high-voltage on-board power supply and/or an electric motor. For example, the vehicle may be designed as a fuel cell vehicle and/or passenger car. For example, in the case of embodiments of electric vehicles, no internal combustion engine is provided in the vehicle, which is then driven exclusively by means of electrical energy.

According to some embodiments, it may be provided that the output assembly is arranged in the vehicle interior, for example in the region of a center console, and the imaging assembly is arranged in the region of an instrument cluster, and/or the center console, and/or an inside mirror, and/or rearview mirror, and/or outside mirror of the vehicle. For example, the imaging assembly may be arranged in the vehicle such that the detection of the driver of the vehicle is possible. It is advisable for example to arrange the imaging assembly on the rearview mirror and/or outside mirror on the side of the vehicle on which the driver of the vehicle is also sitting. It is furthermore also conceivable to expand detection by the imaging assembly to other occupants of the vehicle. Alternative assemblies in or on the vehicle, and/or also the use of other imaging assemblies, are then correspondingly suitable.

Other advantages, features and details will become apparent from the following description, in which exemplary embodiments will be described in detail with reference to the drawings.

In the FIGS. below, the same reference signs are used for the same technical features, even in different exemplary embodiments.

Specific references to components, process steps, and other elements are not intended to be limiting. It is further noted that the FIGS. are schematic and provided for guidance to the skilled reader and are not necessarily drawn to scale. Rather, the various drawing scales, aspect ratios, and numbers of components shown in the FIGS. may be purposely distorted to make certain features or relationships easier to understand.

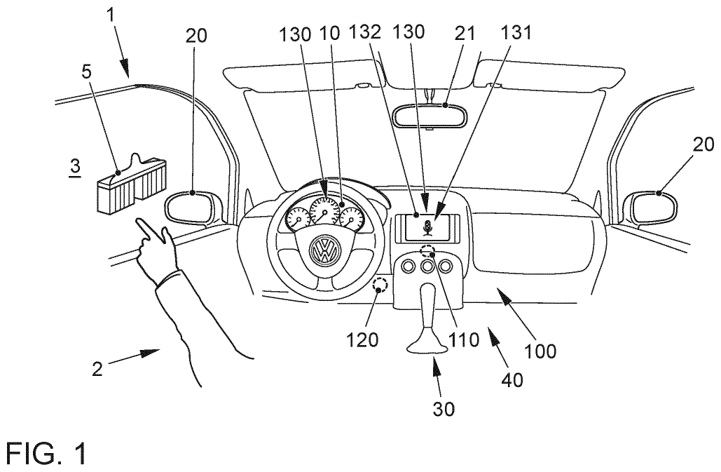

FIG. 1 schematically depicts a system 100 for a vehicle 1 to provide a speech dialog in sign language. The depiction is from the perspective of a vehicle occupant 2 in a vehicle interior 40. An imaging assembly 110 is shown that may serve to detect input information from the vehicle occupant 2. In this regard, the imaging assembly 110 optically monitors the vehicle interior 40 to visually record the vehicle occupant 2. In addition, other vehicle occupants 2 may also be detected by the imaging assembly 110 if applicable.

A processing assembly 120 is furthermore provided for evaluating the detected input information, wherein the processing assembly 120 is for example designed as a vehicle electronics system. It may also be possible for the evaluation to be partially done by external components such as an external data processing system. To do this, the processing assembly may for example communicate with the external data processing system, for example through a network such as a mobile phone network and/or the Internet. In this way, additional resources may be used for evaluation.

Moreover, an output assembly 130 for visual output in sign language may be provided depending on the evaluation. Normally, in a speech dialog system, the input by the user as well as the answer by the system 100 (and/or vice versa) is through acoustic speech. Herein, at least the answer by the system 100 is in sign language. This accordingly enables communication with the vehicle 1 even when communication via spoken language is impossible.

The imaging assembly 110 may be designed as a camera, for example an infrared camera, in order to at least optically detect a gesture of the vehicle occupant 2 via the input information. The gesture in this case is for example part of the sign language. Moreover, the input information may also at least comprise information on a facial expression, and/or silently spoken words, and/or body posture of the vehicle occupant that may also be part of the sign language. This makes it possible to digitally record the sign language by using this information.

Moreover, the gesture detected via the input information may also be another gesture that is specific to additional information. The additional information may therefore be detected in addition to the information on the sign language. The additional gesture for example consists in pointing toward an object 5 (pointing with a finger of the vehicle occupant 2 is shown, which provides the directional information). The additional information is then the information of the indicated object 5. This additional information may for example also be determined by evaluating the input information, for example if this also comprises information on the object 5, or respectively the outer region of the vehicle 1, or it may also be determined by evaluating the detection of at least one additional imaging assembly (such as the outer region of the vehicle 1). In the evaluation, this makes it possible to evaluate a command or question transmitted using the sign language, and to compare it with the additional information. Information on the object 5 that was indicated may then be determined as the answer.

The output assembly 130 may comprise at least one display 132, for example an LED display, for the vehicle interior 40 in order to output the visual output 131 as a visualization of an answer to the input information in the sign language, wherein the output assembly 130 is exemplary designed as an instrument cluster 10 for the vehicle 1.

Moreover, the output assembly 130 in the vehicle interior 40 may for example be arranged in the region of a center console 30, and the imaging assembly 110 may be arranged in the region of an instrument cluster 10, and/or the center console 30, and/or a rearview mirror 21, and/or an outside mirror 20 of the vehicle 1.

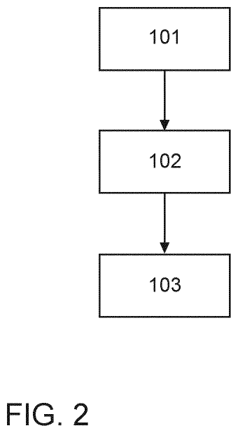

FIG. 2 visualizes a method to provide a speech dialog in sign language in a speech dialog system for a vehicle 1. In a first method step 101, optical detection of input information of a vehicle occupant 2 may be performed. In a second method step 102, an evaluation of the detected input information is performed. Then, in a third method step 103, visual output 131 may be provided in sign language depending on the evaluation.

The description of the embodiments given above describes the present invention exclusively within the scope of examples. Of course, individual features of the embodiments may be combined freely with one another, to the extent that this is technically feasible, without departing from the scope of the present invention.

### LIST OF REFERENCE NUMERALS

1 Vehicle, motor vehicle
2 Vehicle occupant
3 Environment
5 Object
10 Instrument cluster
20 Outside mirror
21 Rearview mirror
30 Center console
40 Vehicle interior
100 System
101-103 Method steps
110 Imaging assembly
120 Processing assembly
130 Output assembly
131 Visual output
132 Display

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments.

The mere fact that certain measures are recited in mutually different dependent claims or embodiments does not indicate that a combination of these measures cannot be used to advantage. Any reference signs in the claims should not be construed as limiting the scope.

What is claimed is:

1. A method to provide a speech dialog in sign language in a speech dialog system for a vehicle, comprising:
optically detecting of input information from a vehicle occupant;
evaluating of the detected input information; and
providing a visual output in sign language depending on the evaluation.

2. The method of claim 1, wherein evaluating of the detected input information comprises:
detecting of an interaction of the vehicle occupant with the speech dialog system in the sign language by using the input information;
performing an analysis of the input information to translate the sign language into contentual translation information that may be evaluated by the speech dialog system;
generating an answer by using the translation information to output the answer in the sign language by the visual output.

3. The method of claim 2, wherein the answer comprises one or more of the following pieces of information:
object information on an object in an environment of the vehicle;
object information on an object in an environment of the vehicle wherein the additional information provides a selection of the object;
object information on an object in an environment of the vehicle wherein the additional information provides a selection of the object as an indicated direction toward the object;
weather information;
environmental information;
environmental information comprising information on a current location of the vehicle;
message information; and
media information.

4. A system for a vehicle to provide a speech dialog in sign language, having:
an imaging circuit for detecting input information from a vehicle occupant;
a processing circuit for evaluating the detected input information;
an output circuit for visual output in sign language depending on the evaluation.

5. The system of claim 4, wherein the imaging circuit is configured as an infrared camera in order to optically detect at least one gesture by the vehicle occupant.

6. The system of claim 4, wherein the output circuit comprises at least one display for the vehicle interior in order to output the visual output as a visualization of an answer to the input information in the sign language.

7. The system of claim 4, wherein the system is configured as a speech dialog system of a method of claim 1 in order to perform the method.

8. A vehicle having a system according to claim 4.

9. The vehicle according to claim 8, wherein the vehicle is an autonomous vehicle.

10. The vehicle according to claim 8, wherein the output circuit is arranged in the vehicle interior and/or in the region of a center console, and the imaging circuit is arranged in the region of an instrument cluster, and/or the center console, and/or a rearview mirror of the vehicle.

11. The method of claim 2, wherein the input information comprises a recorded image of the vehicle occupant in order to detect the interaction as a gesture by the vehicle occupant by using the recorded image.

12. The method of claim 2, wherein the contentual translation information is text information.

13. The method of claim 2, further comprising detecting of another gesture of the vehicle occupant using the input information that is specific to additional information.

14. The method of claim 3, wherein the information is filtered with respect to an availability of an output of the information in the sign language to generate the answer.

15. The system of claim 6, wherein the output circuit is configured as an instrument cluster for the vehicle.

16. The system of claim 5, wherein the output circuit comprises at least one display for the vehicle interior in order to output the visual output as a visualization of an answer to the input information in the sign language.

17. The system of claim 16, wherein the output circuit is configured as an instrument cluster for the vehicle.

18. The vehicle according to claim 9, wherein the output circuit is arranged in the vehicle interior and/or in the region of a center console, and the imaging circuit is arranged in the region of an instrument cluster, and/or the center console, and/or a rearview mirror of the vehicle.
